(19) United States
(12) Patent Application Publication
(10) Pub. No.: US 2020/0024035 A1
(43) Pub. Date: Jan. 23, 2020

(54) BEVERAGE CONTAINER LABELING SYSTEM

(71) Applicant: John William Davidson, Amityville, NY (US)

(72) Inventor: John William Davidson, Amityville, NY (US)

(21) Appl. No.: 16/287,919

(22) Filed: Feb. 27, 2019

Related U.S. Application Data
(60) Provisional application No. 62/700,612, filed on Jul. 19, 2018.

(51) Int. Cl. B65D 25/20; B65D 23/14; G09F 3/00; G09F 3/10

(52) U.S. Cl. CPC B65D 25/205; B65D 23/14; G09F 2003/0222; G09F 3/10; B65D 2203/02; G09F 3/0288

(57) ABSTRACT

A beverage container labeling system including a label having an outer surface an engaging surface, a plurality of removeable stickers, and a removable cover. The label is defined by the outer surface and the engaging surface and includes the plurality of removeable stickers disposed about a top-edge and a bottom-edge of the label. The engaging surface of the label has adhesive such that the engaging surface of the label is configured to be adhesively applied to a surface of a beverage container. The removeable cover may be peeled off to expose the plurality of removeable stickers for use. The plurality of removeable stickers include functional indicia displayed thereon. The plurality of removeable stickers may be selectively removed from the label and re-applied to the surface of the beverage container providing a modular, customizable and user-arranged personal message.

### CROSS REFERENCE TO RELATED APPLICATION

The present application is related to and claims priority to U.S. Provisional Patent Application No. 62/700,612 filed Jul. 19, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of labels and more specifically relates to container labels.

### 2. DESCRIPTION OF RELATED ART

Plastic bottles are common storage containers for liquid beverages. Multiple people, especially at a social event or work office setting, may be drinking from the same beverage bottles. Individuals may put down their drink and have difficulty identifying which bottle is theirs. Further, some beverage bottles may be boring and uninspiring—people may be looking for new ways to functionally customize the bottles. A suitable solution is desired.

U.S. Pat. No. 2016/026,4299 to Xiangdong Zhang relates to identifying indicia for beverage containers. The described identifying indicia for beverage containers include a beverage container which comprises a label. The label includes sections that are designed to be selectively removed. A plurality of indicia associated with the sections identify the removed sections.

### BRIEF SUMMARY OF THE INVENTION

In view of the foregoing disadvantages inherent in the known label art, the present disclosure provides a novel beverage container labeling system. The general purpose of the present disclosure, which will be described subsequently in greater detail, is to provide a unique labeling system for plastic bottles and cups.

A beverage container labeling system is disclosed herein. The beverage container labeling system includes a label having an outer surface, an engaging surface, a plurality of removeable stickers, and a removeable cover. The label is defined by the outer surface and the engaging surface and includes the plurality of removeable stickers disposed about a top-edge and a bottom-edge of the label. The engaging surface of the label comprises adhesive. The engaging surface of the label is configured to be adhesively applied to a surface of a beverage container. The plurality of removeable stickers include functional indicia including but not limited to alphanumeric characters, numeric characters, symbols, pictures, seasonal-pictures, and the like displayed thereon. The removeable cover is configured to be peeled off to expose the plurality of removeable stickers for use. The plurality of removeable stickers are configured to be selectively removed from the label and re-applied to the surface of the beverage container providing a modular, customizable and user-arranged personal message. The embodiments disclosed herein are functional in nature to provide utility to the users thereof.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a beverage container labeling system, constructed and operative according to the teachings of the present disclosure.

FIG. 1 is a perspective view of the beverage container labeling system during an ‘in-use’ condition, according to an embodiment of the disclosure.

FIG. 2 is a perspective view of the beverage container labeling system of FIG. 1, according to an embodiment of the present disclosure.

FIG. 3 is a perspective view of the beverage container labeling system of FIG. 1, according to an embodiment of the present disclosure.

FIG. 4 is a perspective view of the beverage container labeling system of FIG. 1, according to an embodiment of the present disclosure.

FIG. 5 is a perspective view of the beverage container labeling system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to labels and more particularly to a beverage container labeling system as used to improve the functional labeling and identifying of various beverage containers.

Generally, the present invention provides plastic bottles and cups with a custom labeling system that offers customers the chance to design and create their own personalized message or label. The label includes a peel-able removable cover and includes numerous different types of stickers including letters, numbers, symbols, seasonal pictures, and much more. The product allows users to label their bottle for convenient identification, which may be especially useful in a work office, at a picnic, outdoor social event, and the like.

The present invention enables individuals to express their creativity and personality on a plastic bottle. The beverage container labeling system allow users to peel the stickers from the bottle or cup and arrange them in a desired fashion to construct a creative personal message. In a preferred embodiment, the stickers feature a clear transparent background and wrap around the container's circumference. Each sticker can have various typography, style, and colors, and there may be additional themed designs for holidays. People can choose how to arrange the stickers to label the bottle/cup or create inspiration or entertaining messages.

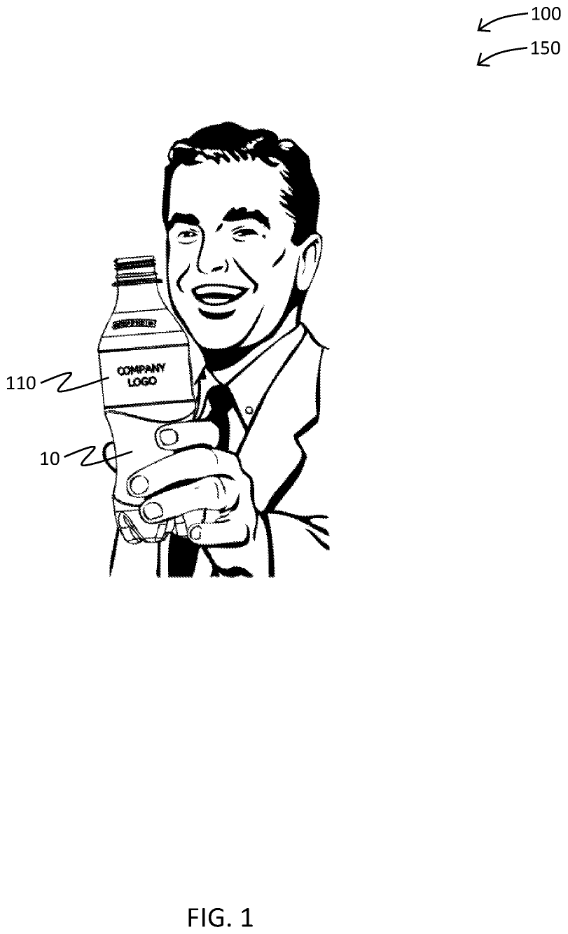

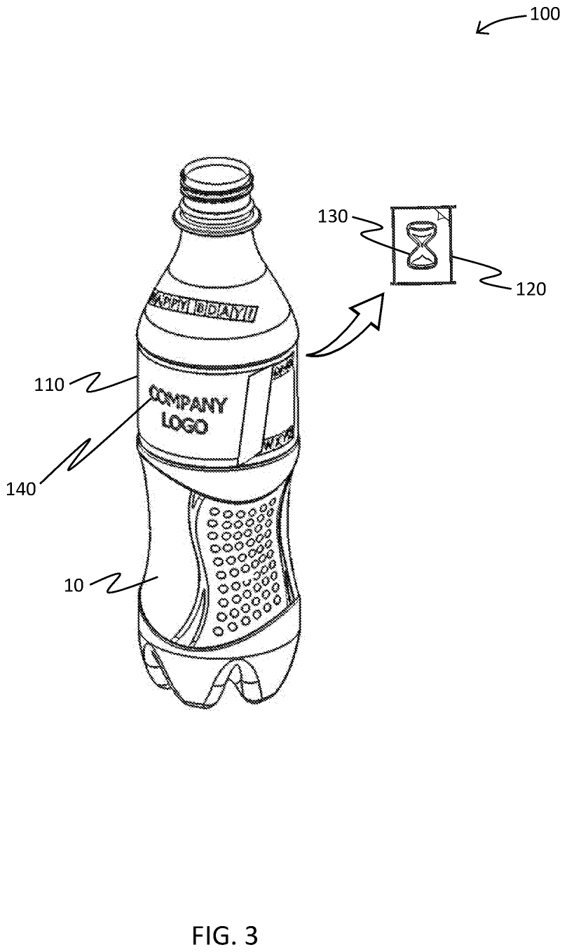

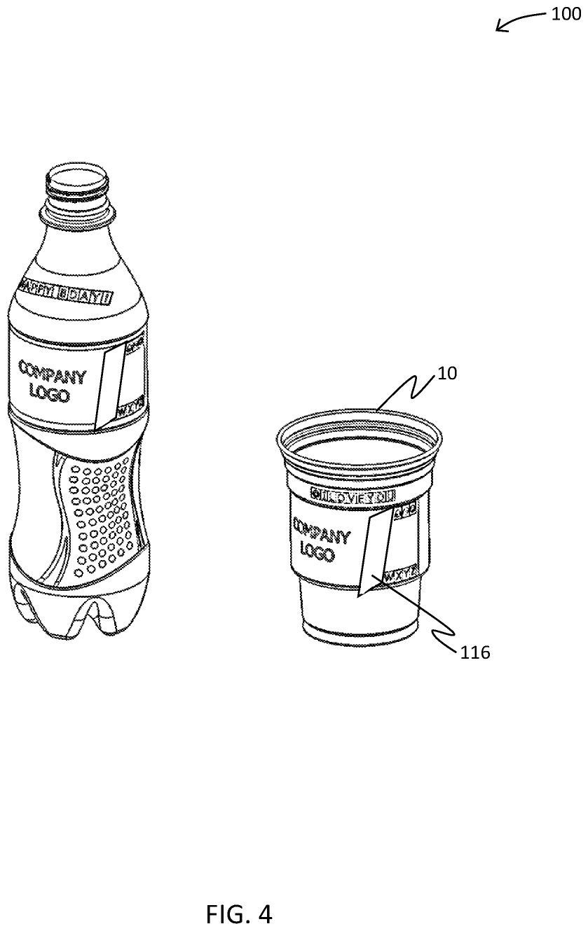

Referring now more specifically to the drawings by numerals of reference, there is shown in FIGS. 1-5, various views of a beverage container labeling system 100. FIG. 1 shows a beverage container labeling system 100 during an ‘in-use’ condition 150, according to an embodiment of the present disclosure. As illustrated, the beverage container labeling system 100 may include a label 110 having an outer surface 112, an engaging surface 114, a plurality of removeable stickers 120, and further includes a removeable cover 116. The label 110 is defined by the outer surface 112 and the engaging surface 114 and includes the plurality of removeable stickers 120 disposed about a top-edge 122 and a bottom-edge 124 of the label 110. The engaging surface 114 of the label 110 may comprise adhesive or other suitable attachment means or removable attachment means. The engaging surface 114 of the label 110 is configured to be adhesively applied to a surface of a beverage container 10. The plurality of removeable stickers 120 include functional indicia 130 displayed thereon. The removeable cover 116 is configured to be peeled off to expose the plurality of removeable stickers 120 for use. The plurality of removeable stickers 120 are configured to be selectively removed from the label 110 and re-applied to the surface of the beverage container 10 providing a modular, customizable and user-arranged personal message.

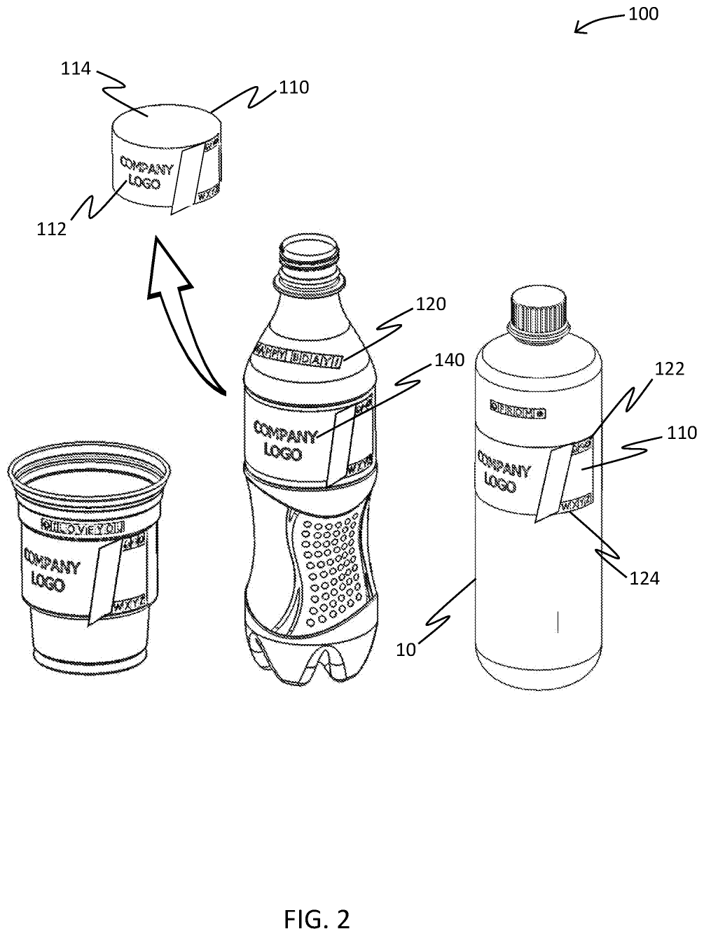

FIGS. 2-4 show various perspective views of the beverage container labeling system 100 of FIG. 1, according to an embodiment of the present disclosure. As above, the beverage container labeling system 100 may include the label 110 applied to a beverage container 10. The label 110 may be applied to a beverage container 10 at a time of manufacturing or user applied after manufacturing. The label 110 is defined by two layers, a first-layer being the label 110 and a second-layer being the removeable cover 116. The removeable cover 116 is adhered to the label 110 and is configured to be removed to expose the removeable stickers 120 and the outer surface 112 of the label 110. The removeable cover 116 may further include a pull tap for assisting a user in removing the removeable cover 116. The label 110 is configured to provide a visual indicator for readily identifying a beverage container 10. The label 110 may partially or fully encircle a beverage container 10.

The plurality of removeable stickers 120 are preferably transparent. The plurality of removeable stickers 120 may be formed in a transparent layer which includes a plurality of sections with the functional indicia 130 displayed thereon. The removeable stickers 120 are detachable from one another such that they can be removed and arranged by a user. In other embodiments, the plurality of removeable stickers 120 may be non-transparent. The functional indicia 130 may include alphanumeric characters, numeric characters, symbols, pictures, seasonal-pictures, and the like.

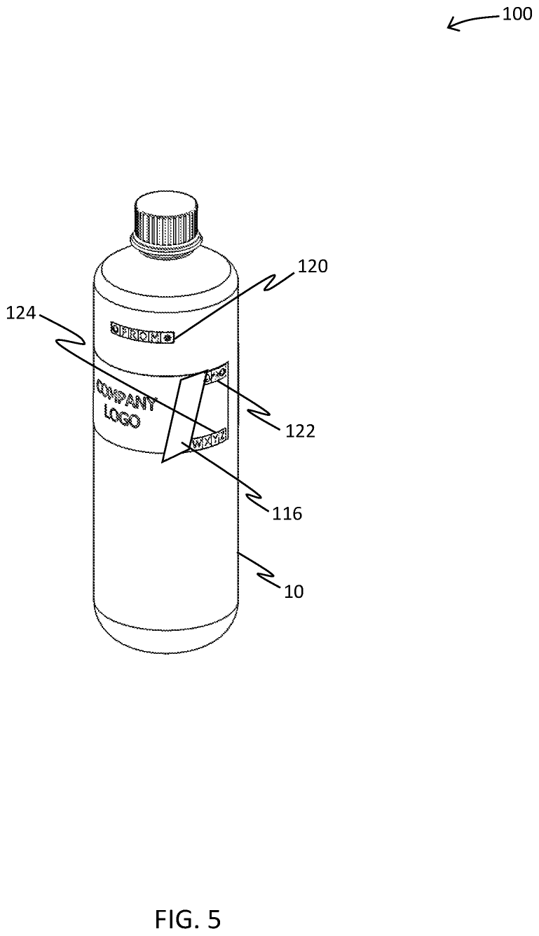

FIG. 5 shows a perspective view of the beverage container labeling system 100 of FIG. 1, according to an embodiment of the present disclosure. As above, the beverage container labeling system 100 may include the label 110 having the outer surface 112, the engaging surface 114, the plurality of removeable stickers 120, and the removeable cover 116. In this embodiment, the label 110 further includes a company-logo-section 140 for indicating a specific beverage-brand of the beverage container 10. The company-logo-section 140 may be positioned on the removeable cover 116 or the outer surface 112 of the label 110. The plurality of removeable stickers 120 are preferably transparent and form a transparent layer configured at the top-edge 122 and the bottom-edge 124 of the label 110. The transparent layer includes a plurality of sections with the functional indicia 130 displayed thereon. The functional indicia 130 may include alphanumeric characters, numeric characters, symbols, pictures, seasonal-pictures, and the like. The removeable stickers 120 are detachable from one another. The label 110 is flexible and contours to a body of the beverage container 10 such as a bottle, can, or cup.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A beverage container labeling system comprising:
a label having
an outer surface;
an engaging surface;
a plurality of removeable stickers;
and
a removeable cover;
wherein said label is defined by said outer surface and said engaging surface, and includes said plurality of removeable stickers disposed about a top-edge and a bottom-edge of said label;
wherein said engaging surface of said label comprises adhesive;
wherein said engaging surface of said label is configured to be adhesively applied to a surface of a beverage container;
wherein said plurality of removeable stickers include functional indicia displayed thereon;
wherein said removeable cover is configured to be peeled off of said label to expose said plurality of removeable stickers for use;
and
wherein said plurality of removeable stickers are configured to be selectively removed from said label and re-applied to said surface of said beverage container providing a modular, customizable and user-arranged personal message.

2. The beverage container labeling system of claim 1, wherein said label is defined by two layers, a first-layer being said label and a second-layer being said removeable cover.

3. The beverage container labeling system of claim 2, wherein said removeable cover is adhered to said label and configured to be removed to expose said removeable stickers and said outer surface of said label.

4. The beverage container labeling system of claim 1, wherein said plurality of removeable stickers are transparent and form a transparent layer configured at said top-edge and said bottom-edge of said label.

5. The beverage container labeling system of claim 4, wherein said transparent layer includes a plurality of sections with said functional indicia displayed thereon.

6. The beverage container labeling system of claim 5, wherein said removeable stickers are detachable from one another.

7. The beverage container labeling system of claim 1, wherein said plurality of removeable stickers are non-transparent.

8. The beverage container labeling system of claim 1, wherein said beverage container is selected from the group consisting of bottles, cans, and cups.

9. The beverage container labeling system of claim 5, wherein said functional indicia includes at least one character selected from the group consisting of alphanumeric characters, numeric characters, symbols, pictures, and seasonal-pictures.

10. The beverage container labeling system of claim 1, wherein said label is non-removeable from said beverage container.

11. The beverage container labeling system of claim 10, wherein said label is flexible and contours to a body of said beverage container as applied.

12. The beverage container labeling system of claim 1, wherein said label further includes a company-logo-section.

13. The beverage container labeling system of claim 12, wherein said company-logo-section is disposed on said removeable cover of said label for indicating a specific beverage-brand of said beverage container.

14. The beverage container labeling system of claim 1, wherein said label is applied to said beverage container during manufacturing and bottling of said beverage containers.

15. The beverage container labeling system of claim 1, wherein said label is user applied to said beverage container after manufacturing of said beverage containers.

16. The beverage container labeling system of claim 1, wherein said removeable cover further includes a pull tap for assisting a user in removing said removeable cover.

17. The beverage container labeling system of claim 1, wherein said label is configured to provide a visual indicator for readily identifying said beverage container.

18. The beverage container labeling system of claim 1, wherein said label fully encircles said beverage container.

19. The beverage container labeling system of claim 1, wherein said label partially encircles said beverage container.

20. A beverage container labeling system, the beverage container labeling system comprising:
a label having
an outer surface;
an engaging surface;
a plurality of removeable stickers;
and
a removeable cover;
wherein said label is defined by said outer surface and said engaging surface, and includes said plurality of removeable stickers disposed about a top-edge and a bottom-edge of said label;
wherein said engaging surface of said label comprises adhesive;
wherein said engaging surface of said label is configured to be adhesively applied to a surface of a beverage container;
wherein said plurality of removeable stickers include functional indicia displayed thereon;
wherein said label is defined by two layers, a first-layer being said label and a second-layer being said removeable cover;
wherein said removeable cover is configured to be peeled off of said label to expose said plurality of removeable stickers for use;
wherein said plurality of removeable stickers are configured to be selectively removed from said label and re-applied to said surface of said beverage container providing a modular, customizable and user-arranged personal message;
wherein said plurality of removeable stickers are transparent and form a transparent layer configured at said top-edge and said bottom-edge of said label;
wherein said transparent layer includes a plurality of sections with said functional indicia displayed thereon;
wherein said removeable stickers are detachable from one another;
wherein said beverage container is selected from the group consisting of bottles, cans, and cups;
wherein said functional indicia includes at least one character selected from the group consisting of alphanumeric characters, numeric characters, symbols, pictures, and seasonal-pictures;
wherein said label is non-removeable from said beverage container;
wherein said label is flexible and contours to a body of said beverage container as applied;
wherein said label further includes a company-logo-section;
wherein said company-logo-section is disposed on said removeable cover of said label for indicating a specific beverage-brand of said beverage container;
wherein said label is applied to said beverage container during manufacturing and bottling of said beverage containers;
wherein said label is configured to provide a visual indicator for readily identifying said beverage container;
and
wherein said label fully encircles said beverage container.
